(19) United States
(12) Patent Application Publication
(10) Pub. No.: US 2013/0021292 A1
(43) Pub. Date: Jan. 24, 2013

(54) Garment with Touch-Sensitive Features

(71) Applicants: Josef Tatelbaum, Shanghai (CN); Dennis Baacke, Irma, WI (US)

(72) Inventors: Josef Tatelbaum, Shanghai (CN); Dennis Baacke, Irma, WI (US)

(21) Appl. No.: 13/555,838

(22) Filed: Jul. 23, 2012

Related U.S. Application Data
(63) Continuation-in-part of application No. 13/204,378, filed on Aug. 5, 2011.
Application No. 13/204,378 is a continuation-in-part of application No. 11/780,587, filed on Jul. 20, 2007.
(60) Provisional application No. 61/510,171, filed on Jul. 21, 2011.
(60) Provisional application No. 60/843,690, filed on Sep. 11, 2006.
(60) Provisional application No. 61/426,890, filed on Dec. 23, 2010.
(60) Provisional application No. 61/420,063, filed on Dec. 6, 2010.
(60) Provisional application No. 61/420,061, filed on Dec. 6, 2010.
(60) Provisional application No. 61/406,310, filed on Oct. 25, 2010.
(60) Provisional application No. 61/510,171, filed on Jul. 21, 2011.

(51) Int. Cl. A41D 1/00; B29C 45/14; G06F 3/044; B08B 1/00

(52) U.S. Cl. 345/174; 2/69; 134/6; 264/271.1

(57) ABSTRACT

A garment including a shell adapted to receive a portion of a finger of a wearer therein, the shell having an interior surface, an exterior surface and an aperture for receiving the finger of the wearer and at least one conductive member disposed on the exterior surface of the shell, the at least one conductive member capable of conducting a signal recognizable by a touch-sensitive device. The garment can also include at least one cleaning material piece thereon to be used to clean a control surface of the device.

### CROSS-REFERENCE TO RELATED APPLICATIONS

This application claims priority as a continuation-in-part application from U.S. Non-Provisional application Ser. No. 11/780,587, filed on Jul. 20, 2007, which claims priority from U.S. Provisional Application Ser. No. 60/843,690, filed on Sep. 11, 2006, and from U.S. Non-Provisional application Ser. No. 13/204,578, filed on Aug. 5, 2011, which claims priority from U.S. Provisional Application Ser. No. 61/426,890, filed Dec. 23, 2010, U.S. Provisional Application Ser. No. 61/420,063, filed on Dec. 6, 2010, U.S. Provisional Application Ser. No. 61/420,061, filed on Dec. 6, 2010, and U.S. Provisional Application Ser. No. 61/406,310, filed on Oct. 25, 2010; as well as from U.S. Provisional Application Ser. No. 61/510,171, filed on Jul. 21, 2011, the entirety of which are each expressly incorporated herein by reference.

### FIELD OF THE INVENTION

The present invention relates generally to a garment, and more specifically to a garment having touch-sensitive features that are formed at least partially of molded and/or foamed materials or components

### BACKGROUND OF THE INVENTION

There are many types of electronic devices that are used for various reasons, including but not limited to, communications, entertainment, work, and maintaining information such as contacts and appointments. Many electronic devices are continuously decreasing in size while increasing in functionality. Several types of electronic devices are portable, such as phones, pagers, communicators, electronic organizers, personal digital assistants, tablet computers and digital audio and/or video playing devices such as iPods® or MP3 players.

The particular controls and methods of input for different electronic devices can vary. Some devices may include mechanical buttons or switches that can be activated by a user contacting the button or switch. Often, conventional hand coverings do not enable a user to accurately select and press a small mechanical button or switch.

Other electronic devices utilize a touch-sensitive technology for the interaction between the user and the device. One example of a touch sensitive technology is a touch screen which is an interactive screen that can be contacted by a user. Another example of a touch-sensitive technology is a track pad. The touch-sensitive technologies or applications sense and track a user's touch and its subsequent movement.

Some applications are resistive-type systems that include a resistive layer of material and a conductive layer of material that are disposed proximate to each other and separated by a narrow space of air. When a user touches a resistive-type screen or pad, the two layers contact each other in that exact spot, thereby changing the electric field and the particular spot can be identified. Thus, a resistive-type system registers a touch or input as long as the two layers make contact. The contact can be made using any type of object.

Other applications are capacitive-type systems that include a conductive layer of material that stores an electrical charge. When a user touches a capacitive-type screen or pad, a portion of the charge is transferred between the user and the screen or pad. As a result, the charge on the capacitive layer changes. Once this change occurs, the particular location of the change can be determined by a controller. A capacitive system needs a conductive input to register a touch or input. Such a conductive input can be made using a portion of a user's body, such as a finger.

In an electronic device with a capacitive-type touch-sensing interface, a controller supplies electrical current to metal channels or conductors that form a grid and conduct electricity. When another conductor, such as a user's finger, is moved close to the grid, current wants to flow to the finger to complete a circuit. Typically, the electronic device includes a non-conductive item, such as a non-conductive piece of plastic, in the way. Thus, a charge builds up at a point on the grid that is the closest to the finger. The build up of electrical charge between two conductors is called capacitance. The controller of the electronic device measures any changes in capacitance and a signal is generated and sent to the microprocessor of the electronic device.

As electronic devices become smaller, the available space for input or control structures on the electronic devices decreases as well. Resistive-type and capacitive-type touch-sensing technologies are utilized on electronic devices. These touch-sensing technologies use capacitive and resistive buttons which can replace the small mechanical button and switch input devices. As mentioned above, capacitive touch-sensing requires a conductive input to register a touch by a user. While a conductive input can be accomplished through the touch of a user, such a conductive input is difficult when a user is wearing a garment covering the portion of the user's body intended to provide the conductive input, such as a hand covering. Garments, such as hand coverings including gloves and mittens are worn for protection from cold weather or other environmental conditions. There is a decrease in tactile sensitivity when a user is wearing a conventional garment. In addition, conventional garments do not allow a user to provide a necessary conductive input to an electronic device. Accordingly, to operate and utilize many electronic devices, a user must remove the garment in order to effectively interact with the devices.

Certain garments have been developed that enable the wearer to interact with a conductive input device without removing the garment by replacing portions of the material forming the garment with section of a conductive material. However, while this enables the individual wearing the garment to interact with the device, the incorporation of the item used to interact with the device into the garment often requires significant modification to the form of the garment.

Additionally, as the garment including the item used to interact with the touch-sensitive device is often worn in outside environments, the garment itself may have some materials thereon, such as dirt, dust, water, etc., that can obscure the interface when contacting the device, resulting in detrimental effects regarding the proper interaction of the garment with the interface of the touch-sensitive device.

Thus, it is desirable to develop a garment that enables the wearer to provide conductive input to an electronic device, but that also has a relatively simple construction. It is also desirable to develop a garment that enables the wearer to provide conductive input to an electronic device, but that also has a uniform and unbroken layer surrounding the body portion of the wearer on which the garment is positioned, such that the garment is effectively weatherproof or waterproof for use in various environments. Further, it is desirable to develop a garment construction that includes sections formed of foamable or moldable, e.g., thermoplastic materials, to provide all of the benefits attendant therewith, but that is constructed in a manner that allows the foamable or moldable section or sections to be attached directly to other sections formed of different foamable, moldable or non-moldable materials, thereby reducing the complexity and expense of the construction for the garment or article of clothing. Additionally, it is desirable that the garment have the ability to remove any obscuring materials from the interface of the touch-sensitive device to maintain or improve the interaction between the garment and the device.

### SUMMARY OF THE INVENTION

Briefly described, one aspect of the present disclosure provides a garment, such as a hand or finger covering including one or more receptacles for fingers and a thumb, among others. The garment also includes at least one conductive member coupled thereto or formed therewith. In one embodiment, the conductive member is formed from one or more materials that facilitate a conductive input to an electronic device and extend along the exterior of the garment such that the conductive member can be positioned in direct contact with an electronic device. In one embodiment, the conductive member is coupled at one end within the interior of the garment in order to be positioned in contact with the wearer. The conductive member is formed from one or more materials that facilitate a conductive input to an electronic device and extends from the interior of the garment through an aperture of the garment that is adapted to receive a portion of the wearer's body therethrough and is spaced from the position of the body portion in the garment. From the aperture, the conductive member extends along the exterior of the garment such that it can be positioned in direct contact with an electronic device. Thus, when in contact with the device, the conductive input from the wearer can be transmitted from the inside of the garment along the conductive member to the electronic device. Alternatively, the aperture can be formed in the garment to provide a more direct path for the conductive member.

According to another object of the present invention, the amount of the conductive material positioned on the exterior of the garment can sufficient to create a detectable input on the device without any direct contact of the conductive member with the body of the wearer, enabling the wearer to interact with the device solely via the conductive member. Thus, instead of having to remove the garment to directly contact the device, or to have a conductive member that penetrates the garment, the conductive member, based on its mass and/or size, is able to provide the necessary input to the device without any direct contact with the body of the wearer.

According to a further aspect of the present invention, the garment can be formed at least partially from a foamable or moldable material that can be injected into a mold to form the garment. The moldable material can be a thermoplastic or foam material, among others and is compressible in the form of the garment and expands and contracts in response to the movement of the body portion disposed within the garment. In addition, the ability to mold the foamable or moldable material enables the garment to be formed without any seams, further enhancing the protective function of the garment.

According to another aspect of the present invention, the garment or article of clothing, which are used interchangeably throughout the application, such as a glove or finger sleeve, is provided in which the article of clothing are formed at least partially of a foamable or moldable and flexible material, and optionally entirely of the foamable or moldable and flexible material, while the remainder of the article of clothing is formed of one or more separate sections of a functionally different material, such as synthetic woven or knit materials or leather, for example. The different materials that can be used as the foamable or moldable and flexible material include any materials that can be utilized in various types of foaming and/or molding processes, e.g., can be injected into a suitable mold in a flowable or liquid state and subsequently solidified, such as thermoset materials, thermoplastic materials, thermoplastic polyurethanes, and one or two component silicone rubbers, among other similar suitable foamable and moldable materials, which can optionally also have conductive properties. Further, throughout this application, when used in reference to the particular sections of the article of clothing formed of the foamable or moldable materials, the term “moldable” shall be construed to include each of these types of materials. Also, the term “non-moldable”, when used in this application in reference to the sections of the article of clothing that are not formed of the flexible “moldable” materials, shall be construed to cover all types of materials that can be used in glove constructions, but that are not moldable, such as textile materials, including fabrics, woven or non-woven materials, and knit materials, among others.

The article of clothing formed with the flexible, foamable or moldable material sections enables the sections of the articles of clothing formed of this material to provide greatly increased functionality, e.g., gripping ability, to the articles of clothing that assists an individual wearing the article of clothing, such as when playing sports. The moldable material utilized in forming these sections of the article of clothing also can be easily modified in a molding process used to form the moldable material portions, such that the moldable material portions can include various additional enhancing features, such as enhanced gripping members, breathable apertures and the like. Also, other features can be secured to the sections of the articles of clothing formed from the moldable materials via more conventional manners including thermal bonding or stitching, such as a lining on the interior of the article of clothing.

According to another aspect of the present invention, the sections of the article of clothing formed of the moldable materials are secured to the sections of the article of clothing formed of the more conventional materials through any suitable molding process, such as an injection molding process. The non-moldable sections of the article of clothing are positioned within a mold conforming to the desired shape of the article of clothing. The moldable material is then injected into the mold to conform to the shape of the mold, and to flow around the exposed edges of the non-moldable material positioned within the mold. As the moldable material cools, it intimately and directly bonds with the non-moldable material to form the construction for the article of clothing. This bonding of the moldable material to the non-moldable material has various added benefits over conventional stitching. These benefits include the reduced size of the seam formed between the moldable material and the non-moldable material, or reduced “seam bulk,” as well as the removal of the requirement for needle holes to allow stitching to pass through the materials, which can allow water to leak through the holes and into the glove in wet conditions.

According to another aspect of the present disclosure, the garment has a projection extending from one or more portions of the garment. The projection is operably connected to the conductive member in order to enable signals generated by the component to be transmitted through the conductive member to the projection. The form of the projection allows the signal to be directed precisely onto the device to enable the wearer to closely and accurately control the operation of the device.

According to a further aspect of the present disclosure, the garment can be formed for use on one or more fingers of the wearer, without any portion of the garment disposed over the back or palm of the hand of the wearer. The garment can be formed as a finger sleeve, having the conductive member disposed on the exterior of the sleeve for interaction with an electronic device.

According to still another aspect of the present disclosure, the garment can be formed with a material located on one or more portions of the garment that is able to clean and/or remove dirt and other particulate matter from the interactive surface of the electronic device to facilitate the control of the device utilizing the conductive member positioned on the garment.

Numerous other aspects, features, and advantages of the present disclosure will be made apparent from the following detailed description together with the drawings figures.

### BRIEF DESCRIPTION OF THE DRAWINGS

The drawings illustrate the best mode currently contemplated of practicing the present disclosure.

In the drawings:

FIG. 1 is a side plan view of a one embodiment of a garment constructed according to the present disclosure;

FIG. 2 is a bottom plan view of the garment of FIG. 1;

FIG. 3 is a top plan view of the garment of FIG. 1;

FIG. 4 is a cross-sectional view along line 4-4 of FIG. 2;

FIG. 5 is a cross-sectional view similar to FIG. 4 of a second embodiment of the garment of FIG. 4;

FIG. 6 is a cross-sectional view similar to FIG. 4 of a third embodiment of the garment of FIG. 4;

FIG. 7 is front plan view of a fourth embodiment of an article of clothing constructed according to the present disclosure;

FIG. 8 is a rear plan view of the article of clothing of FIG. 7;

FIG. 9 is a top plan view of a thumb portion of the article of clothing of FIG. 7;

FIG. 10 is a bottom plan view of the thumb portion of FIG. 9;

FIG. 11 is a cross-sectional view along line 11-11 of FIG. 9;

FIG. 12 is a side plan view of a finger portion of the article of clothing of FIG. 7;

FIG. 13 is a top plan view of the finger portion of FIG. 12;

FIG. 14 is a partially broken away, bottom plan view of one of the fingers of the finger portion of FIG. 12;

FIG. 15 is a cross-sectional view along line 15-15 of FIG. 7;

FIG. 16 is a partially broken away, cross-section view of a fifth embodiment of the article of clothing constructed according to the present disclosure;

FIG. 17 is a cross-sectional, side plan view of a sixth embodiment of the article of clothing of the present disclosure; and

FIG. 18 is a partially broken away cross-sectional view of the tip of a finger of the article of clothing of FIG. 17.

### DETAILED DESCRIPTION OF THE INVENTION

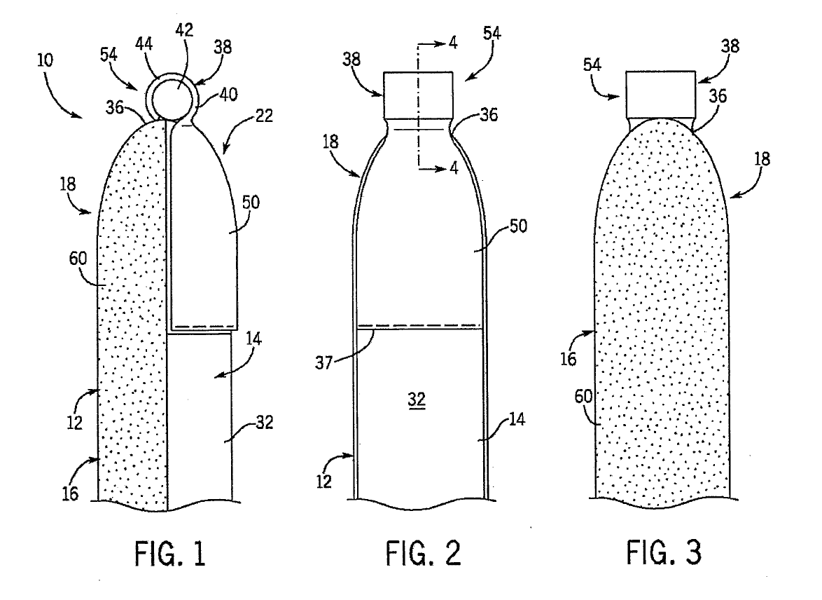

Referring now in detail to the drawing figures, wherein like reference numerals represent like parts throughout the several views, one embodiment of a garment constructed according to the present disclosure is illustrated generally at 10 in FIG. 1. The garment 10, which in this embodiment is formed as a finger stall or sleeve 18 but can also be any type of garment worn by an individual, includes a shell 12 formed of a suitable waterproof or weather proof material. The shell 12 is shaped to conform to the portion of the body of the wearer on which the garment 10 is to be worn. In the illustrated embodiment, the shell 12 is formed to conform to the shape of a finger 28 with a palm portion 14, and a back portion 16, though in other embodiments the garment 10 can be formed to accommodate more than one finger and/or the hand of an individual, or can be formed to be releasably attachable to another garment. In one embodiment illustrated in FIGS. 5 and 6, the shell 12 is formed as a single member, without any breaks in the shell 12 such that the shell 12 provides continuous waterproof and/or weatherproof protection over the entire hand of the wearer, though a shell 12 formed of multiple components joined to one another to form the unitary or single member is also contemplated. Further, the sleeve 18 can be formed from any suitable natural or synthetic material, but in one embodiment is formed of a flexible material that is able to conform to the shape of a finger 28 of the wearer as the finger 28 moves. The sleeve 18 also includes a cuff 39 that is positioned around an opening 41 defined by the sleeve 18 to receive the finger 28 of the wearer can additionally be formed with an elastic member (not shown) therein that either partially or totally extends around the cuff 39 and operates to expand and frictionally hold the sleeve 18 in position on the finger 28.

In the embodiments of FIGS. 5 and 6, the material forming the shell 12 is selected from various moldable materials that provide the water- and weather-proof attributes, but that can also be utilized in conventional molding techniques to form the shell 12. The moldable materials can be selected from any suitable material, such as a thermoplastic or thermoset material, or a foam material which also has the capability to compress and expand in response to the movement of the finger 28 within the shell 12, such that the shell 12 does not restrict the movement of the finger 28, or easily become damaged as a result of the movement of the shell 12 along with the finger 28.

Referring now to FIGS. 1-4, the garment 10 additionally includes a conductive member 22. The conductive member 22 is formed of a flexible and electrically conductive material such that electrical signals can pass along the conductive member 22. The conductive member 22 is attached to the exterior surface 32 of the shell 12 and includes a first conductive portion 50 and a second conductive portion 52. The first portion 50 and second portion 52 are formed of a suitable conductive material, such as a silver plated or copper/polyester taffeta strip material that is 0.08 mm in thickness with a mass of 80 g/m². In one embodiment, the first portion 50 is approximately 1″ in length and 0.5″ in width, and extends along an exterior surface of the shell 12 from a tip 36 of the finger stall 18 to an aperture 37 formed in the shell 12. The second portion 52 is approximately 1″ in length and 0.5″ in width, and is connected to the first portion 50 through the aperture 37, from which the second portion 52 extends along the interior surface 26 of the shell 12, optionally to the tip 36.

At the tip 36, the first portion 50 is optionally joined to a contact 54, that in one embodiment is formed approximately 0.75″ in length and 0.5″ in width strip of a suitable conductive material, such as a silver plated polyester/Lycra® fabric that is 0.50 mm in thickness with a mass of 130 g/m², and is folded to form the contact 54. The first portion 50 is joined to the contact 54 just below the tip 36 of the finger stall 18, or can be integrally formed with the contact 54.

For the contact 54, the contacts 54 are positioned on the exterior surface 32 of the shell 12 at a location where the contacts 54 can interact with an input or control element (not shown) of an electronic device (not shown), including, but not limited to, phones, pagers, communicators, electronic organizers, personal digital assistants, tablet computers, and digital audio and/or video playing devices such as iPods® and MP3 players. In the embodiment shown in FIGS. 1-4, the second portion 52 of the conductive member 22 is positioned in contact with the finger 28 of the wearer and transmits the electric signal along the second portion 52, through the aperture 37 to the first portion 50, and to the contact 54 which is positioned in engagement with a touch-sensitive device than can sense the signal.

In order to engage and provide input to the device, the wearer manipulates the finger stall 18 on which the contact 54 is located to place one of the contacts 54 in contact with the control element of the device. Where the control element of electronic device is or includes a capacitive-type touch-sensing interface, the first portion 50 and second portion 52, with the contacts 54 in contact with the capacitive-type touch-sensing interface generates a conductive signal that is transmitted to the contacts 54 to operate the interface.

In an alternative embodiment shown in FIG. 5, the conductive member 22 can be positioned to wrap around the cuff 39 formed on the shell 12 that defines the opening 41 through which the finger is to be inserted into the shell 12, thereby eliminating the aperture 37 that could compromise the integrity of the waterproof and/or weatherproof properties, etc., of the garment 10.

In still another embodiment shown in FIG. 6, the conductive member 22 can be formed of only the first portion 50 and optionally the contact 54, where the total conductive mass of the first portion 50, optionally along with the mass of the contact 54, is sufficient to generate a signal when the conductive member 22 is in contact with a touch-sensitive device to that is recognizable by and can operate the device without having any direct contact of the first portion 50 with the body of the wearer. In this manner the wearer can interact with the device using the garment 10 without removing the garment 10, and without the garment 10 being formed with any apertures, holes or other points of entry into the garment 10 that could compromise the integrity of the waterproof and/or weatherproof properties, etc., of the garment 10.

In addition to the flexible conductive fabrics, the conductive member 22 can be formed as any suitable conductive device or material having sufficient mass to conduct, or independently generate in the embodiment of FIG. 6, an electric signal that is detectable by a touch-sensitive device to operate the device, such as a conductive ink or adhesive positioned on the interior surface 26 and exterior surface 32 of the shell 12, such as by printing the ink or adhesive thereon, or multiple conductive members 22 can be disposed on the various portions of the shell 12 to form separate or connected points of contact on the exterior surface 32 of the shell 12. Further, the material used to form the shell 12 can be formed with conductive properties, including but not limited to conductive material threads or fibers, such that the shell 12 can directly function as the conductive member 22.

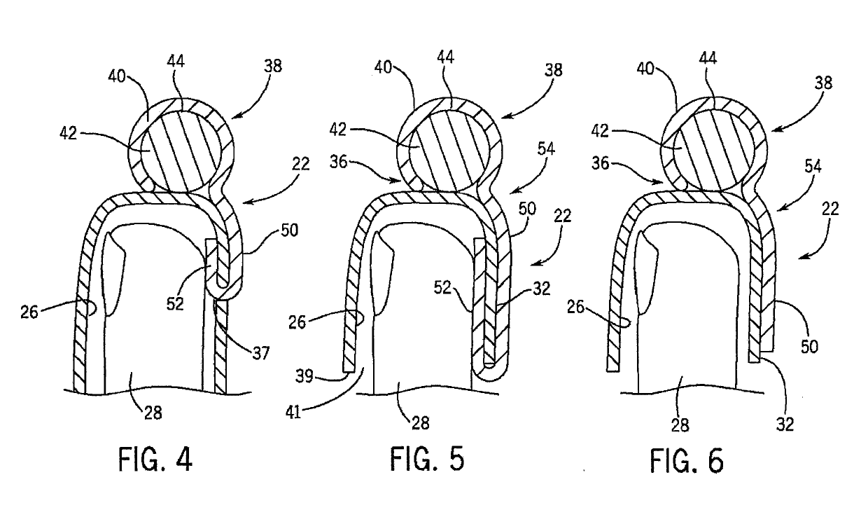

Looking now at FIGS. 4-6, in these embodiments the optional contact 54 includes a projection 38 disposed on the tip 36 of the stall 18. The projection 38 includes an outer portion 40 and an inner portion 42. The outer portion 40 is operably connected to the conductive member 22 at the tip 36 of the stall 18, such that signals travelling along the member 22 can be conducted onto the outer portion 40, which is also formed from a conductive material. Additionally, the outer portion 40 can be formed as an extension of the conductive member 22.

The outer portion 40 is affixed to the tip 36 of the finger stall 18 by any suitable means such as by stitching or an adhesive, among others, and either partially or totally covers the inner portion 42. The inner portion 42 is disposed against the tip 36 of the stall 18 and projects outwardly therefrom. The inner portion 42 tapers or narrows in some manner from the tip 36 towards the outermost end 44 of the inner portion 42, e.g., can be inwardly angled or curved, with one exemplary embodiment of the inner portion 42 being the illustrated cylindrical inner portion 42 disposed lengthwise against the tip 36, such the that the approximate length the overall projection 38 extends outwardly from the tip 36 is defined by the diameter of the inner portion 40, though other orientations of the cylinder forming the inner portion 42 are also contemplated. The tapering of the inner portion 42 provides a narrow engagement surface that is capable of contacting a conductive device. The outer portion 40 is positioned over the inner portion 42 such that the outer portion 40 conforms to the shape of the inner portion 42, thus providing a single, small contact point of the conductive member 22 on the tip 36.

In this manner the projection 38 provides a contact point on the garment 10 for the conductive member 22 that enables very precise contact of the conductive member 22, via the outer portion 40 of the projection 38, with the conductive device, such that a wearer can precisely control the device without having any stray or multiple contact points between the conductive member 22 and the device interfering with the wearer's control of the device. Additionally, the form and placement of the projection 38 on the tip 36 enables the wearer to see the outermost end 44 of the projection 40 opposite the tip 36, such that the wearer can precisely direct the end 44 of the projection 40 into engagement with the device. In one embodiment, the projection 40 is positioned on the tip 36 closer to the back portion 16 of the glove 10, such that the projection 40 is disposed in a more visible location when the garment 10 is in use.

In another embodiment, the sleeve 18 can be formed only partially of the flexible or stretchable natural or synthetic, or moldable material. This material is used to form the palm or lower portion 14 of the sleeve 18, while the back or upper portion 16 is formed of a material 60 capable of picking up and/or removing dirt, grease or other material from the surface of the touch sensitive device. In certain embodiments, this material 60 can take the form of a suede, cotton, cotton blend or microfiber-type material. This material 60 is used to form the upper portion 16 of the sleeve 18 such that it can be readily engaged with the device to clean the control surface and facilitate the operation of the device using the sleeve 18. This material 60 can also be utilized to form additional portions of the stall 18 or other garment 10 to provide the associated cleaning function.

In addition, the material 60 can also be formed to be a removable separate layer on the exterior surface 32 of the shell 12 of the garment 10 or sleeve 18, such that it can be removed, disposed of and cleaned or replaced when dirtied sufficiently to reduce its cleaning capabilities. Also, the size of the material 60 secured to the garment 10 or sleeve 18 can be selected to be larger than that of the upper portion 16 of the sleeve 18 in order to prevent the material 60 from impeding the stretchable and flexible nature of the material forming the garment 10 or sleeve 18. Additionally, multiple pieces of the material 60 can be utilized on the garment 10 or sleeve 18.

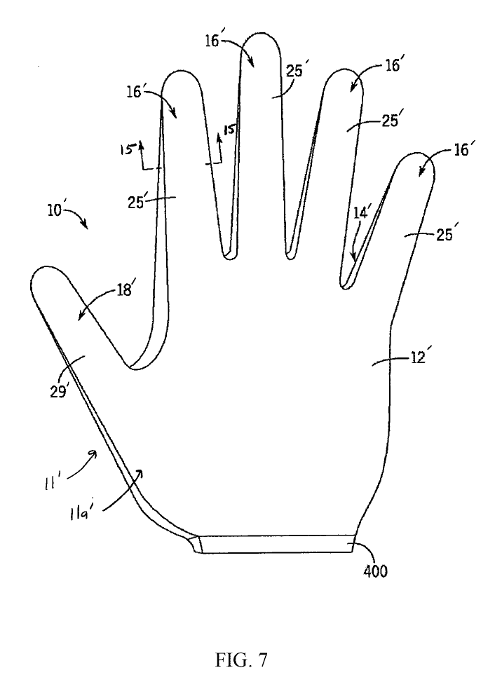

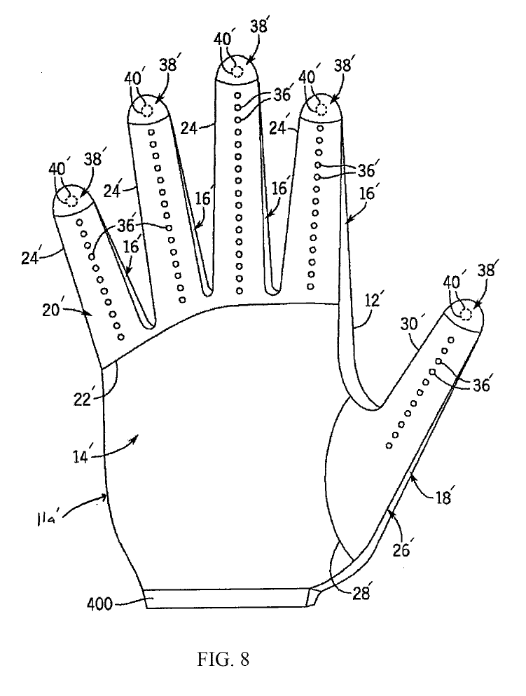

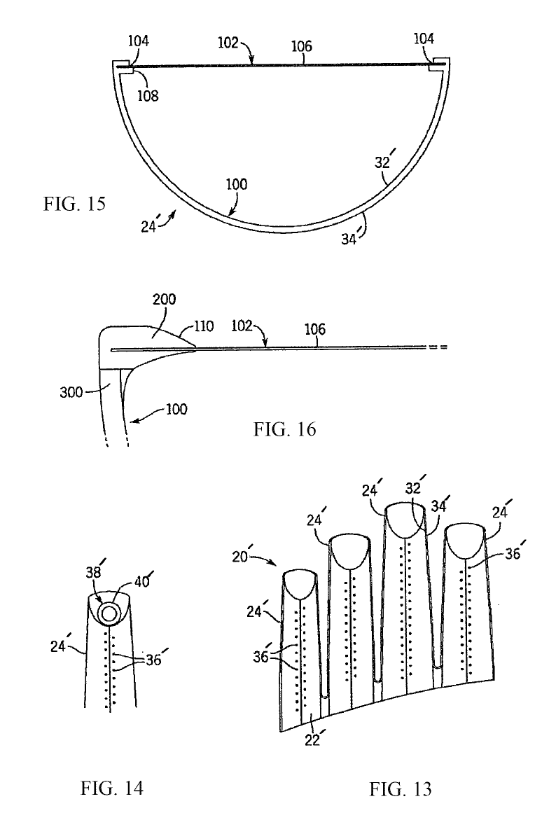

Referring now to FIGS. 7-15, in another embodiment the article of clothing 10′ is constructed as a glove 11′ that includes a shell 11a′ formed with a back portion 12′ and a palm portion 14′ that are joined to one another along their periphery to form the majority of the glove 11′. A number of finger stalls 16′ extend outwardly from the back portion 12′ and the palm portion 14′, in addition to a thumb stall 18′ spaced from the finger stall 16′. However, it is also contemplated that the glove 11′ can be formed without the thumb stall 18′, and/or without one or more of the finger stalls 16′, in order for the construction of the glove 11′ to conform to the particular use to which the glove 11′ is to be put. In each of the varied constructions of this embodiment, the glove 11′ will still be formed with the back portion 12′ and the palm portion 14′ joined to one another and designed to cover at least the palm and back of the hand of the wearer.

Looking now at FIGS. 7, 8 and 12-15, in a one embodiment of the construction for the glove 11′, the finger stalls 16′ of the glove 11′ are at least partially formed of a moldable section 20′. The moldable section 20′ includes a base portion 22′ that is secured to and extends outwardly from the palm portion 14′, and a number of separate finger portions 24′ extending outwardly from the base portion 22′ opposite the palm portion 14′. Each of the finger portions 24′ of the moldable section 20′ are secured to a non-moldable portion 25′ forming the remainder of the finger stall 16′ in order to form completely enclosed finger stalls as is known with prior art glove configurations. The non-moldable portions 25′ are preferably integrally formed with the non-moldable material constituting the back portion 12′ of the glove 11′, but may also be separately formed from the back portion 12′ in order to increase the ease of construction of the glove 11′.

In an alternative embodiment for the moldable section 20′, the finger portions 24′ of the moldable section 20′ can be constructed as a tubular member with one open end (not shown) to form the entire finger stall 16′. The finger portions 24′ in this embodiment have the open end disposed adjacent the base portion 22′, such that the open end allows for the finger of a wearer to be inserted into the respective finger portion 24′ through the open end. Further, in this embodiment, the moldable section 20′ can include a pair of base portions 22′, such that the base portions 22′ on each side of the moldable section 20′ are connected to the palm portion 14′ and back portion 12′ of the glove 10′, respectively.

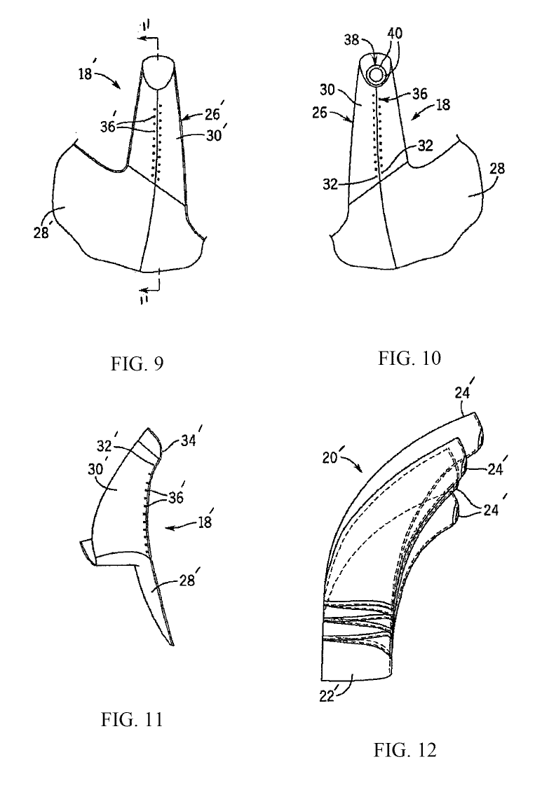

Similarly, looking now at FIGS. 9-11, the thumb stall 18′ includes a moldable section 26′ that includes a base portion 28′ connected to the palm portion 14′ and a thumb portion 30′ extending outwardly therefrom and secured to a non-moldable portion 29′ forming the remainder of the thumb stall 18′ in order to form a completely enclosed thumb stall as is known with prior art glove configurations. Also similarly to the construction for the finger stalls 16′, a thumb stall 18′ with open ends is also contemplated, as is a construction where the non-moldable portions 29′ is preferably integrally formed with the non-moldable material constituting the back portion 12′ of the glove 10′, but that may also be separately formed from the back portion 12′ in order to increase the ease of construction of the glove 11′. Further, the thumb portion 30′ of the moldable section 26′ can be constructed as a tubular member with one open end (not shown) to form the entire thumb stall 16′. The thumb portion 30′ in this embodiment has the open end disposed adjacent the base portion 28′, such that the open end allows for the thumb of a wearer to be inserted into the thumb portion 30′ through the open end. Further, in this embodiment, the moldable section 26′ can include a pair of base portions 28′ on opposite sides of the thumb portion 30′, such that the base portions 28′ on each side of the moldable section 26′ are connected to the palm portion 14′ and back portion 12′ of the glove 10′, respectively.

The various moldable sections 20′ and 26′ utilized in the formation of the glove 11′ are preferably formed of flexible materials, and more preferably from materials that provide various benefits to individuals wearing the glove 11′ including the sections 20′ and 26′. Such materials include, but are not limited to, various polyolefins, polyurethanes, and other flexible foamable, moldable and/or thermoset materials, such as one or two component silicone rubber compositions. Further, the moldable materials selected for use in forming the moldable sections 20′ and 26′ of the glove 11′ preferably have a durometer ranging from Shore 10 to Shore 80 A, with a durometer of approximately Shore 40 A being especially preferred. Additionally, when the moldable sections 20′ and 26′ are formed, they preferably have a thickness of between about 0.3 mm to about 1.2 mm, with a most preferred thickness for the moldable sections 20′ and 26′ being about 0.6 mm. Also, the thickness of the sections 20′ and 26′ can vary across the sections 20′ and 26′, such that different areas of each section 20′ and/or 26′ have different thicknesses from one another.

In addition to the flexibility of the materials, the moldable materials utilized to form the sections 20′ and 26′ must be capable of being utilized in an injection molding process, or other suitable molding process, whereby the moldable material forming the sections 20′ and 26′ is conformed by the mold to result in the desired shape for the various sections 20′ and 26′. In a preferred construction, the sections 20′ and 26′ are formed in the molding process such that the respective finger portions 24′ and the thumb portion 30′ are generally curved in shape to conform to the shape of the fingers and thumb of a wearer in the relaxed position.

In forming the sections 20′ and 26′ using the selected molding process, such as the process developed by Universal Trim Supply Co. of Taipei Hsein, Taiwan, various additional features can be added to the sections 20′ and 26′, and specifically to each of the finger portions 24′ and the thumb portion 30′, as desired. These features can be integrally formed with the individual section 20′ and 26′, such as by forming the additional features during the same molding process for the sections 20′ and 26′, or in a subsequent molding process that integrally bonds or forms the features on the sections 26. Further, depending on the particular form of the additional feature, that feature can be secured to the appropriate section 20 and/or 26 in a more conventional manner, such as by utilizing a suitable adhesive or a mechanical fastening means, such as stitching.

Those additional features which can be formed directly on or with the moldable sections 20′ and 26′ can be formed on the interior surface 32′, the exterior surface 34′ or both surfaces of the various sections 20′ and 26′. For example, as shown in FIGS. 10 and 14, one or more of the various finger portions 24′ and thumb portion 30′ can be formed to include a number of apertures 36′ therein, allowing airflow into and out of the finger portions 24′ and thumb portion 30′. These apertures 36′ can be formed in the sections 20′ and 26′ during the initial molding of the sections 20′ and 26′ as a result of certain features present in the mold used to form the sections 20′ and 26′, or can be punched through the sections 20′ and 26′ after molding. Preferably, the apertures 36′ are formed after the formation of the sections 20′ and 26′ by utilizing a laser to cut through the material forming the sections 20′ and 26′ in a closely-controllable manner to form apertures 36′ having the desired size and shape.

Another feature that can be added to one or more of the respective finger portions 24′ and thumb portion 30′ on the sections 20′ and 26′ is a number of gripping members 38′ to enhance the ability of a person wearing the glove 10′ to grasp an object. The gripping members 38′ can be formed on the sections 20′ and 26′ during the initial molding of the sections 20′ and 26′ as a result of certain features present in the mold used to form the sections 20′ and 26′. Thus, the gripping members 38′ can have any suitable form, such as suitable protrusions, knobs or other geometric or spherical structures, with a preferred form being a closely spaced arrangement of generally conical micro-teeth 40′. Also, the various gripping members 38′ can be disposed at any point along the moldable sections 20′ and 26′, although in the preferred embodiment including the micro-teeth 40′, the teeth 40′ are disposed on the exterior surface 34′ of the finger and thumb tip areas of each section 20′ and 26′. In other embodiments for the glove 11′, the gripping members 38′ can be formed on the interior surface 32′ of the section 20′ and 26′, to provide added slip resistance characteristics and/or comfort attributes to the glove 11′.

Furthermore, in another embodiment of the present invention, instead of forming each of the finger portions 24′ integrally with the base portion 22′, the portions 24′ can be formed individually from one another such that one or more of the finger portions 24′ can be formed using the selected moldable material, and optionally removable from the glove 11′ while other finger stalls 16′ are formed of more conventional materials, such as a textile material or leather, or can be omitted entirely. In this embodiment, the base portion 22′ for the section 20′ is secured to the palm portion 14′ and/or back portion 12′, depending on the configuration for the moldable section 20′, while the non-moldable finger components are secured to the palm portion 14′ and/or back portion 12′ in a conventional manner, e.g., utilizing an adhesive or a mechanical fastening means, such as stitching.

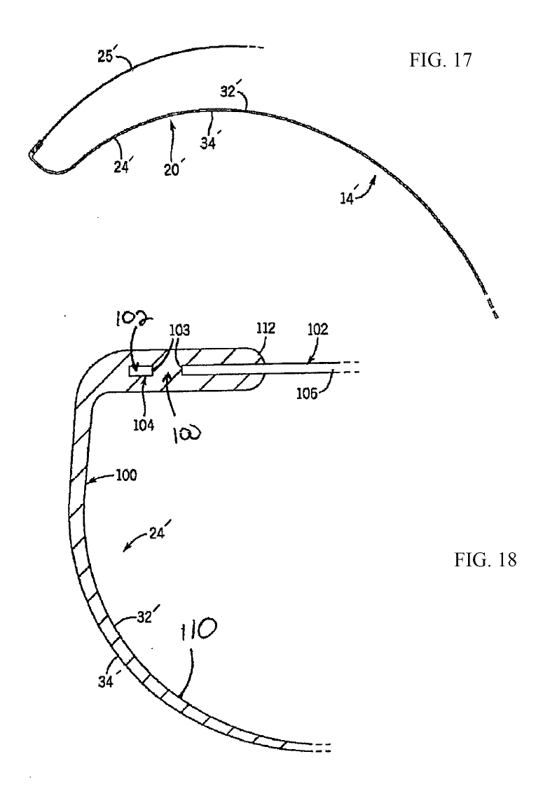

In still another embodiment of the glove 11′ of the present invention, the entire back portion 12′ and/or palm portion 14′ can include one or both of the sections 20′ and 26′, and, thus can be formed from the flexible, moldable material such that only one or neither of the back portion 12′ or palm portion 14′ of the glove 11′ is formed of a conventional glove material. In a preferred version of this embodiment, as best shown in FIGS. 17-18, the palm portion 14′ is formed integrally with the moldable section 20′. During the molding process, the palm portion 14′ is formed to have a curved shape that generally conforms to the actual shape of the hand of a wearer, allowing the palm portion 14′ and the glove 11′ overall, to more closely fit the hand of a wearer. With this shape for the palm portion 14′, the material forming the palm portion 14′ does not bend, or bunch up similarly to prior art glove constructions when the wearer of the glove 11′ flexes his or her hand within the glove 11′, such that the tactile properties of the glove 11′ are enhanced with respect to prior art glove construction.

This increased tactile attribute of the glove 11′ can further be enhanced during the formation of the palm portion 14′ by utilizing a mold for the palm portion 14′, regardless of whether the palm portion 14′ is integrally formed with the other moldable section 20′ and/or 26′, having a variable thickness across the mold. This varying thickness for the mold results in the formation of a palm portion 14′ that has thinner areas of the palm portion 14′ at locations where contact is normally made between the palm portion 14′ and an object, such as a ball, bat or other sporting item, to provide enhanced tactile response to the hand of the wearer through the reduced thickness areas. Additionally, the as stated previously concerning the moldable sections 20′ and 26′, these sections 20′ and 26′, as well as a the individual finger portions 24 and thumb portion 30′, can also be formed to have variable thicknesses across the various parts of the glove 11′ formed from the moldable material, in order to provide the same enhanced tactile attributes to those parts of the glove 11′.

As stated previously, any combination of the various glove portions 12′, 14′, 20′ and 26′ can be formed of the moldable material, with the remainder of the portions 12′, 14′, 20′ and/or 26′ being formed on a more conventional glove material. If one or more adjoining portions 12′, 14′, 20′ and/or 26′ are formed from the moldable material, these portions can be secured to one another in any suitable manner used to connect members formed from a moldable material, such as by molding or bonding the portions to one another, or simply integrally forming the portions with each other in a single molding process.

Also, for those sections 12′, 14′, 20′ and 26′, formed of a non-moldable material and disposed immediately adjacent one another, those sections of the glove 11′ can be secured to one another any suitable securing means, such as by stitching or by otherwise suitably bonding the sections to each other, such as by conventional adhesive or thermal bonding techniques.

Looking now at FIGS. 15, 16 and 18, with regard to securing the various moldable parts 100 to the non-moldable parts 102, such as portion 25′ of the finger stall 16′ of FIG. 7, initially the non-moldable parts 102 are formed to have the desired shape in light of the proposed structure for the glove 11′. Next, these pre-formed non-moldable parts 102 are positioned within the mold (not shown) for the moldable parts 100 of the glove 11′ at the proper locations for the non-moldable parts 102 in the finished glove construction. The positioning of the non-moldable parts 102 in the mold exposes the a selected portion of the peripheral edge 104 of each non-moldable part 102, while completely covering or obscuring those areas 106 of the non-moldable parts 102 that are to be exposed in the final glove construction. Then the moldable material selected to be used in forming the moldable parts 100 is introduced into the mold in a suitable manner, such as by utilizing the process developed by Universal Trim Supply Co. of Taipei Hsein, Taiwan. The moldable material flows through the mold and around each of the exposed edges 104 of the non-moldable parts 102 disposed in the mold. Once the moldable material has completely filled the mold cavity, the material is allowed to cool, thereby forming the moldable part 100 for the glove 11′ having the desired components, e.g., the desired number of finger portions 24′ or thumb portion 30′, the desired number of base portions 22′ or 28′, the desired number, form and positioning of any gripping members 38′, and the desired thickness of the various areas of the moldable parts 100. The cooling of the moldable material within the mold also enables the moldable material, which is urged into intimate and inter-engaging contact with the exposed edges 104 of the non-moldable parts 102 in the mold upon introduction of the moldable material into the mold, to solidify around the exposed edges 104 of the non-moldable parts 102 in a manner that intimately bonds and engages the moldable material part 100 with the exposed edge 104 of the non-moldable part(s) 102 without the need for any additional securing or attachment members, such as adhesives or stitching. Preferably, the moldable parts 100 are secured and bonded to the non-moldable parts 102 on both sides of the non-moldable parts 102, such that the non-moldable parts 102 are sandwiched between separate portions of the moldable parts 100 adjacent the parts 102 in an overlapping configuration. However, it is also contemplated that the moldable parts 100 can be formed to overlap the non-moldable parts 102 on only one side of the parts 102, if desired or necessary. Also, to assist in integrally securing the moldable parts 100 to the non-moldable parts 102, the non-moldable parts 102 can be formed with apertures 103 adjacent the peripheral edge 104 through which the material forming the moldable parts 100 can flow when being formed with the non-moldable parts 102. The material forming the moldable parts 100 solidifies within the apertures 103 when cooled, further securing the overlapping portion of the moldable parts 100 to the non-moldable parts 102.

As a result of this process, in another embodiment for the glove 11′, the moldable part 100 forms the bottom, sides, and a part of the top of the various parts of the glove 11′, while the non-moldable part 102′ forms the majority of the top surface of the respective part of the glove 11′. However, the non-moldable parts 102 can also be formed to form the entire top of each glove portion, or even to form part of the sides of the glove portions, if desired or necessary.

As best shown in FIG. 16, it is also possible to form the moldable part 100 of separate moldable materials, such that the part 100 includes a first material 200 molded in engagement with the edge 104 of the non-moldable part 102 in the manner described previously, and a second material 300 molded into engagement with the first material 200. In this construction, as a result of the use of different moldable materials, the moldable parts 100 of the glove 11′ can be formed with even more varied properties due to the different properties or attributes of the different materials 200 and 300 forming the moldable parts 100 of the glove 11′.

Further, the shape of the portion of the moldable part 100 that is secured to the edge 104 of the non-moldable part 102 can be varied, such as between an annular shoulder 108, a tapered edge 110, and a curved edge 112, to provide a various profiles for the exterior of the glove 11′.

In addition to the aforementioned embodiments, the glove 11′ can be formed with a liner (not shown) formed of a suitable insulating or wicking material, e.g., a woven or non-woven knit material, can be secured to the interior surface 32′ of the glove 11′. The liner can be secured directly to the entire interior surface 32′ of the glove 11′, or to only one or more parts of the interior surface 32′ of the glove 11′, or only to certain points disposed about the interior surface 32′ when the liner only covers a portion of the interior surface 32′ of the glove 101.

Also, the glove 11′ can be formed with a cuff member 400 secured to the back portion 12′ and the palm portion 14′ of the glove 11′ opposite the finger stalls 16′ and thumb stall 18′. The cuff member 400 is secured to each of the back portion 12′ and palm portion 14′ of the glove 11′ via a suitable non-stitching technique to provide a stitching margin (not shown) on each of the back portion 12′ and the palm portion 14′ to enable a separate cuff (not shown) to be attached to the glove 11′ by stitching without damaging the moldable materials used in the formation of the palm portion 14′ and/or the back portion 12′.

While the above description has focused on the glove 11′ as the primary embodiment of the article of clothing 10′, it is also contemplated that other articles of clothing 10′ can be manufactured with one portion of the article formed of a flexible, moldable material that is secured directly to a second portion of the article that is not formed of a moldable material. These other articles of clothing 10′ can include garments to be worn on the torso or legs, shoes, or braces, such as flexible medical braces, among others.

Various other embodiments of the present invention are contemplated as being within the scope of the filed claims particularly pointing out and distinctly claiming the subject matter regarded as the invention.

1. A garment comprising:
a) a shell formed at least partially of a moldable material and adapted to receive at least a portion of a body of a wearer therein, the shell having an interior surface, an exterior surface and an opening for receiving the finger of the wearer;
b) at least one conductive member disposed on the exterior surface of the shell, the at least one conductive member capable of conducting a signal recognizable by a touch-sensitive device.

2. The garment of claim 1 further comprising a cleaning material attached to the shell.

3. The garment of claim 1 wherein the at least one conductive member is formed from a conductive fabric material.

4. The garment of claim 3 wherein the at least one conductive member is affixed to a projection disposed on the exterior surface of the shell.

5. The garment of claim 4 wherein the projection includes an inner portion secured to the exterior surface of the shell and an outer portion secured to the inner portion and optionally the shell.

6. The garment of claim 5 wherein the inner portion has an inwardly tapering shape.

7. The garment of claim 5 wherein the outer portion is integrally formed with the conductive member.

8. The garment of claim 2 further comprising a first conductive portion disposed on the exterior surface and a second conductive portion disposed on the interior surface and connected to the first conductive portion.

9. The garment of claim 8 wherein the conductive member extends through an aperture in the shell to connect the first conductive portion and the second conductive portion to one another.

10. The garment of claim 8 wherein the conductive member extends through opening aperture in the shell to connect the first conductive portion and the second conductive portion to one another.

11. The garment of claim 2 wherein the at least one conductive member is formed of a flowable material capable of adhering to the exterior surface of the shell.

12. The garment of claim 1 further comprising a contact disposed on the exterior surface of the shell and formed of a conductive material, the contact operably connected to the at least one conductive member.

13. The garment of claim 1 wherein the shell is formed as a unitary structure.

14. The garment of claim 1 wherein the shell comprises:
a) a back portion;
b) a palm portion formed of the moldable material and secured to the back portion, wherein the palm portion is integrally engaged with at least a portion of a peripheral edge of the back portion.

15. The garment of claim 14 wherein the palm portion overlaps an interior surface and an exterior surface of the back portion.

16. The garment of claim 16 wherein the palm portion extends from the interior surface of the back portion to the exterior surface of the back portion through apertures in the back portion.

17. The garment of claim 14 wherein the palm portion is secured to the back portion without stitching.

18. A method of interacting with an electronic device having a capacitive-type touch-sensing interface, the method comprising the steps of:
a) a shell formed at least partially of a moldable material and adapted to receive at least a portion of a body of a wearer therein, the shell having an interior surface, an exterior surface and an aperture for receiving the finger of the wearer and at least one conductive member disposed on the exterior surface of the shell, the at least one conductive member adapted to conduct a signal recognizable by a touch-sensitive device;
b) inserting the finger of the wearer through the aperture; and
c) placing the at least one conductive member in contact with the touch-sensitive device.

19. The method of claim 18 wherein the garment further comprises a cleaning material attached to the shell, and wherein the method further comprises the step of wiping the device with the cleaning material either prior to or after placing the at least one conductive member in contact with the device.

20. A method of forming a garment having touch-sensitive properties, the method comprising the steps of:
a) forming a back portion of a shell of the garment from a non-moldable material having a peripheral edge;
b) placing the back portion within a mold used to form a palm portion of the garment in a position that exposes at least a portion of the peripheral edge of the back portion;
c) introducing an amount of a moldable, flexible material into the mold around the portion of the peripheral edge of the back portion; and
d) allowing the moldable, flexible material forming the palm portion to bond with the portion of the peripheral edge of the back portion.

21. The method of claim 20 wherein the back portion of the shell is formed with a number of apertures adjacent the peripheral edge, and wherein the step of allowing the moldable material forming the palm portion to bond with the peripheral edge of the back portion comprises the steps of:
a) allowing the moldable material to flow through the apertures; and
b) enabling the moldable material to solidify in an overlapping configuration over an interior surface and an exterior surface of the back portion and within the apertures in the back portion.
